(19) United States
(12) Patent Application Publication
(10) Pub. No.: US 2013/0132134 A1
(43) Pub. Date: May 23, 2013

(54) Worldwide Billboard that includes a worldwide event search engine, a worldwide service search engine, a mechanism for posting and announcing events and services, a mechanism for uploading information regarding services and events, a mechanism for writing comments regarding services and events, a mechanism for making reservation for services and events, a mechanism for giving grades to the services and events

(71) Applicants: Koroush Amini, Tehran (IR); Foruzan Mehdiani, Tehran (IR)

(72) Inventors: Koroush Amini, Tehran (IR); Foruzan Mehdiani, Tehran (IR)

(21) Appl. No.: 13/472,501

(22) Filed: May 16, 2012

Related U.S. Application Data
(60) Provisional application No. 61/488,795, filed on May 23, 2011.

(51) Int. Cl. G06F 17/30

(52) U.S. Cl. CPC G06F 17/30864
USPC 705/5; 707/706

(57) ABSTRACT

A Worldwide Billboard that includes a worldwide event search engine, a worldwide service search engine, a mechanism for posting and adding events, services, information regarding services and events, comments regarding services and events, a mechanism for making reservation for services and events, a mechanism for grading to the services and events. Basically, this invention functions based on time and location (place). The current invention performs a search for services and events based on their time of occurrence and place of occurrence. This is a search for what is happening in a specified time, and in a specified district, specified country or the world. Users have access to all required information around the world in one website, information such as events, available services, people's comments, and critique's reviews.

### CROSS-REFERENCE TO RELATED APPLICATIONS

This application claims the benefit of U.S. Provisional Application No. 61/488,795, filed May 23, 2011.

### BACKGROUND OF THE INVENTION

The invention described herein relates to the field of computer software and more specifically it is configured to locate all types of events all over the world, locate all types of services all over the world, post and announce all types of events, post and announce all types of services, post and announce detailed information, and comments regarding events and services all over the world, make reservations for services and events, giving grades to the events and services.

Due to the globalization, the world has become a Global Village. In this Global Village, events are organized for various reasons. Community engagement, public notification, marketing, customer relations, advertising, public relations, corporate communication, research, employee engagement, charity, and celebration are just a few of these reasons. These events include events of all sizes from the Olympics down to a breakfast meeting for ten business people. For example, many industries will hold events of some size in order to market themselves, build business relationships, raise money, celebrate, etc.

It seems like every single day we are surrounded in a pool of events; leisure events such as leisure sports, concerts, film premieres, and fashion shows; cultural events such as religious ceremonies, heritage shows, and folklore exhibitions; personal events such as weddings, birthdays, and anniversaries; and finally organizational events such as product launches, expos, corporate meetings, and press conferences.

In this Global Village where we are surrounded in a pool of events, people are confused and they have no idea what events and happenings are going to occur at a given time around the world.

However, one should be able to know the different options she/he has for spending time. When one is sitting at his house/office/hotel room, he/she should be able to know exactly what events are happening each and every second of the day and choose among those events. One going to a trip should be able to plan his trip easily and what he is going to do during his trip for pleasure, work, study or etc. One living in a city should be able to have enough information regarding the events happening around him; so that, he can make the best choice for spending his time.

On the other hand, the Global Village is filled with all types of services; tourist and recreational services, such as hotels, restaurants and bars; personal services such as hairdressers and beauty institutes; maintenance services such as cleaning services; delivering services such as insurance companies; distributive services such as transport services and communication companies. Not knowing about the available services confuses people more and more. People do not know what services are available, how to choose among the available services, which one to choose, which one is the best, which one is the cheapest, which one has the best quality, etc.

Therefore, one should have enough knowledge regarding services too. A wife wanting to have a romantic dinner with her husband, should be able to know about available baby sitter services and people's comments about the service; one wanting to take a trip and going to a seminar should be able to have enough information regarding various seminars, and flight schedules and prices. He should also be able to make reservations and he should be able to do all that in one website.

Furthermore, a shopping mall preparing a grand opening, a designer organizing a fashion show, two schools arranging a friendly game of football, a governor who wants to organize a meeting to listen to the people's problems, a bank that wants to announce its available loans, etc. should have access to a user-friendly technique to announce the events and/or services to other people; a method other than the usual channels of communication which include publications, radio, television, and word of mouth. With other channels of communication, events and services may be announced for a limited number of people whereas with the current invention, events and services will go public for the whole wide world.

Therefore, there is a need for: a search engine that focuses on the events around the world, a search engine that focuses on the services around the world, a website that allows users to post event information and inform others about the upcoming events, a website that allows users to post service information and inform others, a website that allows users to write their comments regarding services and events and gives them grades, a website that allows users to add information to the service's and event's information, a website that provides a method for making reservation for events and services. The Worldwide Billboard covers all of the above in one website; it also covers the gap that exists in the World Wide Web while searching for an event and/or service. So far, no websites has been developed that does all the above altogether at one place.

Gathering services and events information at one place, a website that is easily accessible and is easy to use, will help us to easily take advantage of the events, and plan and schedule a to-do-list for our time, for pleasure, study, work or etc., for everyday life and the future.

In today's world and with the already developed inventions, in case a person travels to a city and decides to go to a restaurant, and then a museum, the traveler should search for all the restaurants throughout the city. Next, she should look at each restaurant's opening hours. At that time, she should make a note of the opening hours and the addresses and she has no way of knowing other people's opinions regarding the restaurants. The user has to perform these steps repeatedly to find the appropriate information. Afterwards, she should search for the city's museums and then look at each one's website to see what time they are open and what their programs are. Finally, the traveler should make another note of the museum's working hours and addresses. Then she should call them and make reservations. In addition, if she wants to leave her kid for a baby sitter while going to the museum, she has to look in the yellow pages and find a baby sitter not knowing whether the baby sitter is good or bad. However, with the current invention, all of the above can easily be done in one website.

The following is a list of current invention's differences with other developed search engines, websites, and software. The current invention focuses not only on all types of events occurring in all countries around the world but it also focuses on all types of services around the world. It collectively gathers events around the world; events are not limited to one district, one city, or one country; it is not limited to particular types of events such as Performing Arts, Music, or Sports; both public and private events may be posted and located. It collectively gathers all services around the world. Selected events and/or services may be sent to an Event and Service Basket and then their information may be printed, removed, updated. All websites in the World Wide Web and the current invention's database will be searched for locating events and/or services. The Worldwide Billboard covers the gap that exists in the World Wide Web while searching for events and services. All events and/or services in the countries, states, and cities may be listed. While searching for event and services, users are presented with all related keywords, event type, service types, date/time, and country/state/city. Reservation for services and events may be done using the current invention. Not only events and services are located, but also other details regarding events and services are retrieved, for example dress code, attendees, etc. People may write their comments regarding the events and services. People may add information to the events and services. People may upload a file for events and service, for example the attendee list for a seminar, or student's grades for a course, or books' excerpts for a library. People may give grades to the events and services. People's comments, information, reviews, grades, uploaded files, etc. may be viewed by others.

Some developed search engines do not focus on any specific criteria. The user enters some keywords, and the search engine merely lists all the websites based on the keywords that the user types in the filtering text box. The users have to engage in a trial and error process for determining a set of keywords, and finding an event or a service. They have to submit a broad set of keywords by trial and error and the search engines will return an overly broad set of matches and perhaps nothing useful.

Furthermore, some search engines have been developed that enable users to locate an event in only one city and not the whole world. Some have been developed to post public events and not private events with no mechanism for making reservations and no mechanism for locating events or services. Some have been developed to locate events but not services. Some have been developed for locating events but not for posting events. Some have been developed for locating events with time and place of occurrence but not other details. Some have been developed for locating events but does not enable users to write their comments, add information, upload files, or give grades.

### BRIEF SUMMARY OF THE INVENTION

The purpose of the current invention is to cover all the users' informational needs with one click and in one website. It is to have access to all the information down to the littlest details around the world in one place, a website, information such as events, available services, people's comments, critique's reviews, etc. The current invention gathers all the events and service information in one website. The user does not need to go to other websites for viewing the information.

The current invention enables users to do all the following in one website: search for events all over the world; search for services all over the world; post and announce public and private events; post and announce services information; write comments and ideas about services and events; grade services and events; post details or upload files regarding events and services; make reservation for events and services; read about events and services down to the littlest details, details such as a restaurants' menu, Banks' loans, and Stores' discounts; read private events' information; read other people's comments; select the desired services and/or events from the search result and send them to an Event and Service Basket and print, remove, or update the basket's information.

In short, the current invention is a Worldwide Billboard that includes a worldwide event search engine, a worldwide service search engine, a mechanism for posting and announcing events and services, a mechanism for uploading information regarding services and events, a mechanism for writing comments regarding services and events, a mechanism for making reservation for services and events, a mechanism for giving grades to the services and events. No websites, software, search engines has ever been developed that enables users to do all this at one place.

In today's society, people are confused about what to do with their time. Accordingly, the current invention helps them to know what is happening every single second of the day around the world, and what services are available for them, so that they can simply manage their time by scheduling their day/week/month ahead of time. It also helps them to post events and services and announce them to other users. Since there are two types of events, public and private, two different mechanisms are needed to satisfy the requirements. A public event may be viewed by everyone, and a private event may be viewed only by a group of people who have access rights to see the event information. The present invention is used for planning and scheduling in all aspects of life, whether it is for work, study, pleasure, or etc. It can be used for scheduling everyday's life, and the future.

All types of events and happenings may be located and posted using the current invention. The events may be among the followings: Movies, Classes and Courses, Trainings, Gatherings, Charities, Seminars, Concerts, Shows, Memorials, Discos, Circuses, Clubs, Matches, Fairs and Festivals, Carnivals, Community Services, Games, Job Fairs, Reunions, Birthdays, Anniversaries, Parties, Massages' Sessions, Holiday Events, Telethons, Weddings, Conferences, Sporting Events, Exhibitions and Trade Shows, Auctions, Grand Openings, Parades, or any other happenings and events. (For a list of useful information, please see Table 2)

Furthermore, all types of services may be located and posted using the current invention. The services may be among the followings: Museums, Banks, Restaurants, Coffee Shops, Bars and Pubs, Art Centers, Galleries, Tours, Zoos, TV Programs, Baby Sitter Services, Nursing Services, Daycare Services, Stores and Shopping Malls, Stores' Sales and Discounts, Parks, Aquariums, Libraries, Fitness Centers, Buses' Schedules, Trains' Schedules, Airplanes' Schedules, Buses' Excursions, Trains' Excursions, Airplanes' Excursions, Buses' Discounts, Trains' Discounts, Airplanes' Discounts, Hotels and Accommodations, Hotels and Accommodations' Prices and Discounts, Therapy Sessions, Massages' Sessions, Doctors, Historical Monuments, Shuttles, or any other services. (For a list of useful information, please see Table 3)

In one embodiment, a method for performing a search is provided; whereas, the search results are events and services. The user is presented with keywords related to the events and services all around the world; the user uses the search engine and looks for his desired event and/or service, specifying his desired time and date and specifying the country or state or city where he is looking for events and/or services; the search query is created based on the selected keywords by user; the search query is used and the search is executed; the search result is returned; the search result is specific to the user's request and it includes information that is specific to the events and services around the world; the user may choose his desired events and/or services and send them to an Event and Service Basket; he may print, modify, or remove the Event and Service Basket information; the user may make reservations. The search engine uses all the websites in World Wide Web, and the current invention's database.

In one embodiment, a method for entering and posting data is provided. The data may be an event, a service, a comment regarding a service or event, details and information regarding a service or event. The user enters his personal information, his username, and his password. He receives a follow-up code. He posts the data and announces it to other users. In case he wants to remove or update the information, he uses the follow-up code and updates or removes the information. Private events may be viewed only by a group of people who have access rights to see the event information; public events may be viewed by everyone. This embodiment includes the followings: posting a public or private event information by user; posting a service by user; posting comments or detail information regarding services and events; storing a public or private event information, service information, comment information regarding services and events, detail information regarding services and events in the database; providing a mechanism for users to grade the services and events; providing a mechanism or users to upload a file regarding services and events; giving access to the users for updating and deleting events, services, comments, detail information; providing a mechanism to a group of users and giving them access to view the private event information; providing a mechanism for public to view the public events, services, comments regarding services and events, grades regarding services and events, and detail information regarding services and events.

Using the current invention has many advantages and solves numerous problems. It helps in: better marketing of products and services; announcing an event to the whole world or a group of people; announcing a service to the whole world or a group of people; launching and introducing a business, a product, etc. to the whole world; better customer relationships; advertising; better public relations; better corporate communication; better community engagement; research; better employee engagement; better public notification; socializing; planning the future; connecting people with their surrounding world; optimizing the usage of time; saving time; making easy reservations; better supplying of products and services by sellers and service providers; reducing and minimizing the people's confusions in scheduling and planning for their time, for pleasure, study, work, or etc.; using various opportunities; hunting for jobs around the world; knowing what is happening, when and where around the world.

There has been many times that we have had some spare time, and we have been confused not knowing what to do with that spare time and we have ended up killing that spare time, not doing anything useful. Not knowing the different options, not knowing what is happening in the city that we are living in (or going to), and not knowing the available services we have all ended up killing that precious time by doing nothing at the end; whereas, we could have spent it to learn something, have fun, help others, etc. Using the present invention the problems such as the above mentioned will never arise.

The present invention is useful for all people who are willing to schedule for their time. Every single person accessing the internet may use the present invention; the only requirement is that the user should be able to use the internet. The user may access it through desktop computers, laptops, cell phones, web kiosks, or any other devices accessing the internet.

### BRIEF DESCRIPTION OF DRAWING

A further understanding of the nature and the advantages of the present invention may be realized by the remaining specifications and the attached drawings.

FIG. 1 is an illustration of the search engine interface in accordance with embodiments of the present invention.

FIG. 2 is an illustration of how the desired event and/or service are selected and how the selected keywords are used for searching purposes according to embodiments of the present invention.

FIG. 3 is an illustration of the Event and Service Basket.

FIG. 4 is an illustration of how reservations are made according to embodiments of the present invention.

FIG. 5 depicts embodiments of an interface showing how the event and/or service is posted and saved according to embodiments of the present invention.

FIG. 6 depicts an embodiment of an interface showing how comments or information is written, how a file is uploaded, how the user grades an event and/or a service according to embodiments of the present invention, and how the user adds detail information.

### DETAILED DESCRIPTION OF THE INVENTION

### Introduction

In the present invention, a website is provided for performing searches that result in the events and/or available services all over the world. Basically, this invention functions based on time and location (place). The current invention performs a search for services and events based on their time of occurrence and place of occurrence. To get this result, a type of query building is provided that constrains the user's input. It provides the user access to the keywords that are specific to the events and services.

In the present invention, a technique is also provided for posting and announcing all types of events, and services; posting and announcing information, and comments regarding events and services all over the world, making reservations for services and events.

### TERMINOLOGY

Throughout the following document, please note the following terms:

Usage of the term “user” may refer to a “human user,” such as a person selecting the keywords in the search query or a person posting the event information.

The term UI refers to the “User interface.” A user interacts with the current invention through the user interfaces.

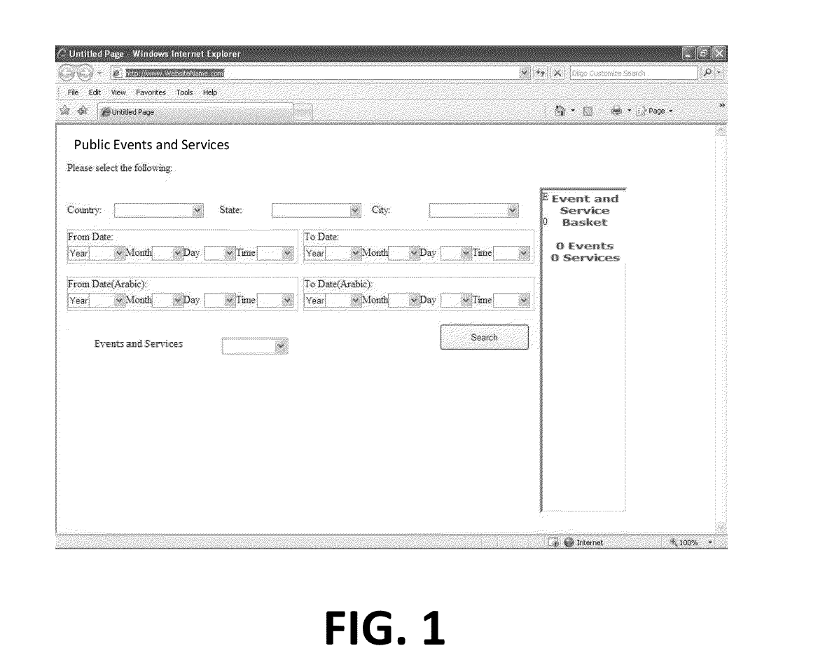

In FIG. 1 through 6, please note the following:

### “User Interfaces” Clarifications

Please note that the presented UIs are provided for a better understanding of the current invention. However, other UIs and other elements on the UI may be used. For example, instead of a drop-down menu for selecting the dates/times, a calendar may be presented to the user; instead of a drop down menu for selecting events and services, they may be presented to the user in a table; instead of presenting the cities in a drop-down menu, a map may be used.

It is also obvious that as the technology advances, other advanced User Interfaces and UI elements may be used.

The scope of the invention may be determined not with reference to the User Interfaces. Embodiments described herein are illustrative only but not restrictive; they should not limit the present invention thereby; many variations of the invention will become apparent to those skilled in the art upon review of the disclosure.

By way of example, embodiments of the invention will be described. It is to be understood that the invention is of broad utility and may be used in many different contexts.

### ILLUSTRATIONS

FIG. 1 shows how the related keywords are presented to the user and how the search is limited for finding a quicker and better search result.

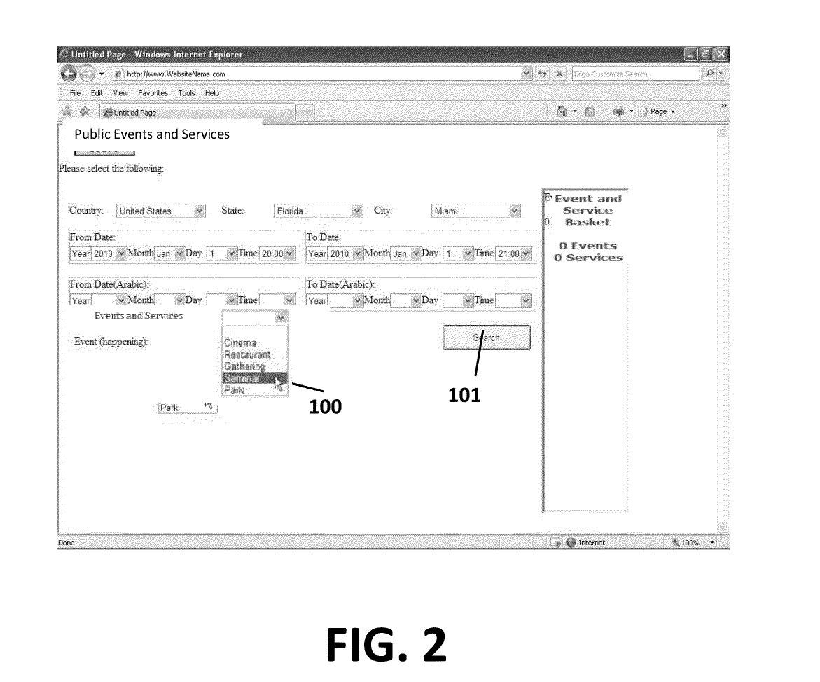

FIG. 2 shows how a specific event or service in specific date and time and location is selected and searched for.

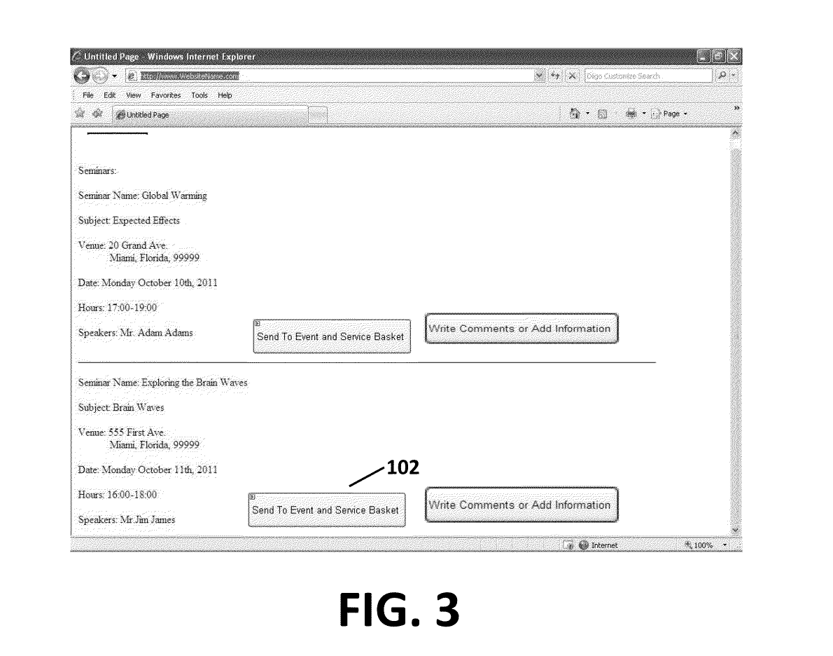

FIG. 3, item 102 shows how a service or event is sent to an Event and Service basket.

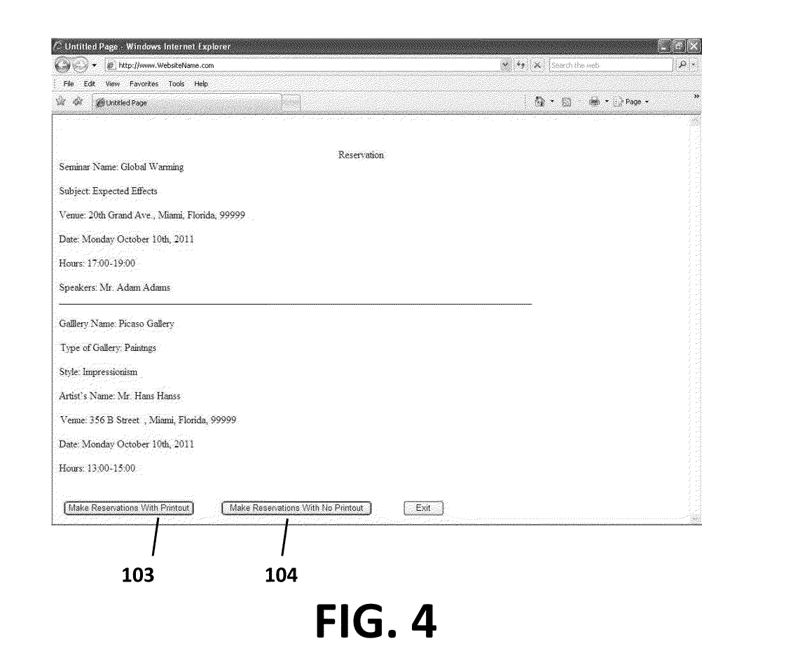

FIG. 4, item 103 shows how a reservation is made with a printout and item 104 shows how a reservation is made without a printout.

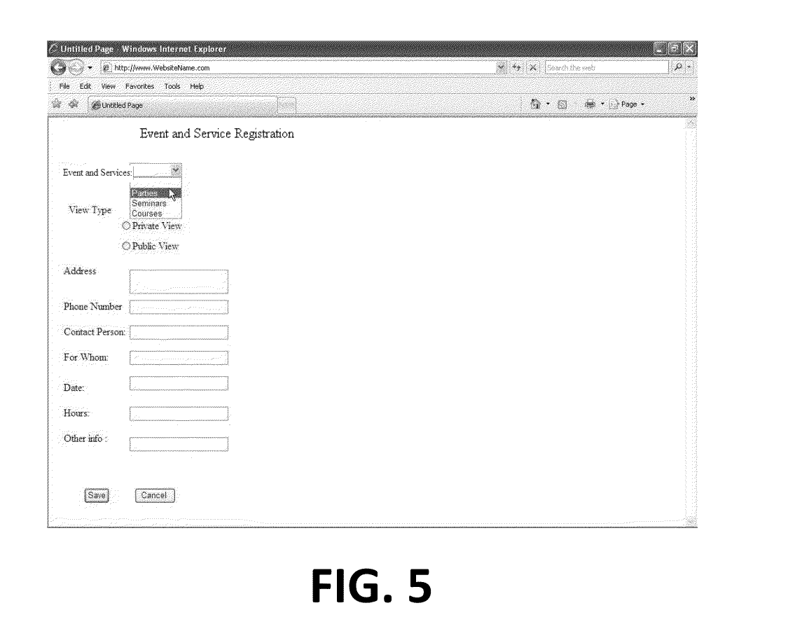

FIG. 5 shows how an event or service is posted and announced either publicly or privately.

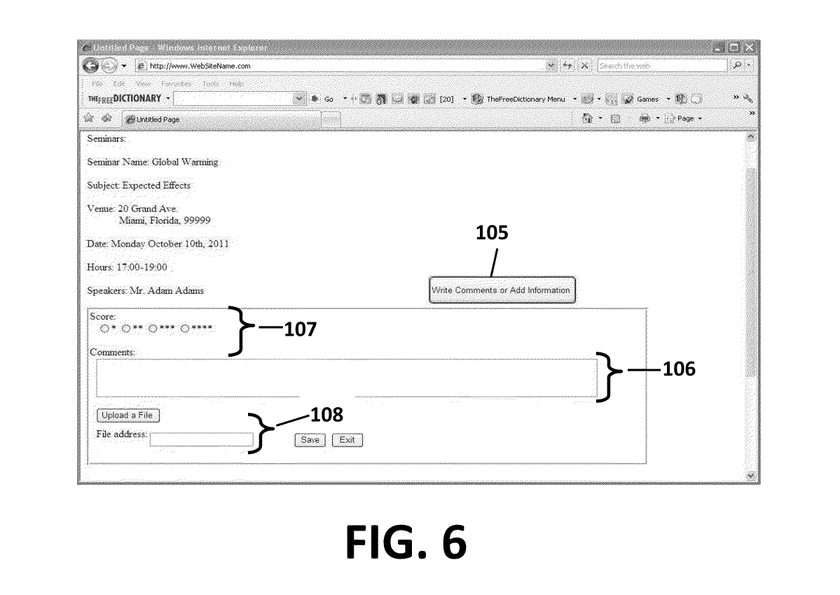

FIG. 6 item 105 and 106 show how a comment is written for an event or service and how detail information is added for a service or event. Item 107 shows how a service or event may be graded by the user. Item 108 shows how a file may be uploaded for a service or event.

### Real Life Samples

Searching for Events and Services:

Imagine that you are sitting at home and you have a day off. You want to have fun or do something useful. However, you have no idea where to go, what to do, or what is going on in the city or streets around you. Using this invention, based on your interests, you can search and see a list of what is happening at 3:00 O'clock or any other times in the location around you.

Suppose you have worked all day and it was a stressful day at work, you have 3 hours before going to sleep and you want to do something fun to lessen the work pressure, you want to know the different options that you have for spending that 3 extra hours and you want to make reservation if necessary.

Another illustration is that one is going to New York from Hamburg. He wants to stay there for 3 days. He wants to know what he can do during his trip, and where he can go. He wants to have a printout of his 3 days' plan.

Another example is a person who has decided to attend a seminar, have lunch, go to a museum, have dinner, and then go to a disco. He does not know what seminars are being offered, what museum to go to, where to have lunch and dinner, what disco to go to. He will use the present invention and he will choose to go to seminar X, have lunch at restaurant B, go to museum C, have dinner at restaurant D, and go to disco Y. He will make a printout of his plan and know exactly what time to go to seminar X, what time to get out and go to restaurant B for lunch, what time to go to museum C, what time to go to restaurant D to have dinner, and what time to go to Disco Y. Furthermore, he uses the present invention to make reservation for Seminar X.

Another sample is a person who is sitting at his office and needs to know about the different loans the banks are offering without going to every single bank's website.

Another instance is a person who is sitting at his house and he has decided to go out, have a t-bone steak, and he does not want to drive in the traffic, he wants to know which restaurant close to his house offers t-bone steaks.

### Posting And Announcing Information, Comments Regarding Events And Services:

Visualize the followings: an auctioneer who needs to announce auctioning Picasso's drawings; an author who has a Book Signing event and needs to announce it to the whole world; an agent who needs to publicize an actor by a public appearance; a pub that needs to advertise for the bar and is using the big screen TV for world cup football; a mayor who needs to make a public appearance to listen to the people's problems; a restaurant owner who wants to post his menu; an airline which wants to post its timetables; a person who needs to write his comment regarding a hotel; a critique who needs to write his review for a restaurant; a student announcing his graduation party to his friends; a couple announcing their wedding to their friends and families; a child announcing her birthday party to her friends; an instructor who needs to post up his students' grades for a seminar; a person who needs to write the attendees list for a memorial.

Table 2 will illustrate what the user will choose for public events, what the search engine will list, what additional information is displayed for each event, and what additional information can the users write or upload. Please note that the search engine will search all websites in the World Wide Web and the Worldwide Billboard's database.

TABLE 2
Public Events

| The User | | | |
|---|---|---|---|
| Will Choose | | | Additional Information that |
| (Events and | Search Engine | Along with These Useful | May Be Written or |
| Happenings) | Will List | Information | uploaded |
| Movie | All the movies that | Name of movie | Critics' reviews |
| | are shown at that | Start and end times | People's opinions |
| | particular | Name of | Actors/actresses' |
| | date/time at the | actors/actresses | background |
| | specified city | Name of Cinema | Advertisements |
| | | A picture or logo | etc |
| | | Venue | |
| | | Contact numbers and | |
| | | email addresses | |
| | | Reservation phone | |
| | | Website | |
| | | etc | |
| Classes and | All the classes and | Name of course | Reviews |
| Courses | courses that are | Detail about course | Student's grades |
| | held at that | Name of instructor | Teacher's evaluation |
| | particular | A picture or logo | Advertisements |
| | date/time at the | Days | etc |
| | specified city | Start and end time | |
| | | Duration | |
| | | For whom | |
| | | Venue | |
| | | Contact numbers and | |
| | | email addresses | |
| | | Reservation phone | |
| | | Website | |
| | | etc | |
| Trainings | All the trainings | Name of training | Reviews |
| | that are held at that | Detail about training | Student's grades |
| | particular | Name of instructor | Teacher's evaluation |
| | date/time at the | A picture or logo | Advertisements |
| | specified city | Start and end time | etc |
| | | Days | |
| | | Duration | |
| | | For whom | |
| | | Venue | |
| | | Contact numbers and | |
| | | email addresses | |
| | | Reservation phone | |
| | | Website | |
| | | etc | |
| Charities | All the charities | Subject | People's donations |
| | that are held at that | For whom | Advertisements |
| | particular | Attendees | etc |
| | date/time at the | A picture or logo | |
| | specified city | Start and end time | |
| | | Days | |
| | | Duration | |
| | | Venue | |
| | | Contact numbers and | |
| | | email addresses | |
| | | Website | |
| | | etc | |
| Seminars | All the seminars | Subject | Reviews |
| | that are held at that | For whom | Student's grades |
| | particular | Attendees | Teacher's evaluation |
| | date/time at the | A picture or logo | Advertisements |
| | specified city | Start and end time | etc |
| | | Days | |
| | | Duration | |
| | | Venue | |
| | | Contact numbers and | |
| | | email addresses | |
| | | Reservation phone | |
| | | Website | |
| | | etc | |
| Concerts | All the concerts | Name of singer or | Critics' reviews |
| | that are performed | group | People's opinions |
| | at that particular | A picture or logo | Singer or groups' |
| | date/time at the | Days | background |
| | specified city | Start and end time | Advertisements |
| | | Name of sponsor | etc |
| | | Music genre | |
| | | Venue | |
| | | Contact numbers and | |
| | | email addresses | |
| | | Reservation phone | |
| | | Website | |
| | | etc | |
| Theatres | All the shows that | Name of theatre | Critics' reviews |
| | are performed at | List of programs | People's opinions |
| | that particular | A picture or logo | Actors/actresses' |
| | date/time at the | Days | background |
| | specified city | Duration | Advertisements |
| | | Start and end time | etc |
| | | Name of actors/ | |
| | | actresses | |
| | | Venue | |
| | | Contact numbers and | |
| | | email addresses | |
| | | Reservation phone | |
| | | Website | |
| | | etc | |
| Shows | All the shows that | Name of Show | Critics' reviews |
| | are performed at | Type of Show | People's opinions |
| | that particular | A picture or logo | Actors/actresses/ |
| | date/time at the | Days | dancers'/ . . . background |
| | specified city | Duration | Advertisements |
| | | Start and end time | etc |
| | | Programs | |
| | | Venue | |
| | | Contact numbers and | |
| | | email addresses | |
| | | Reservation phone | |
| | | Website | |
| | | etc | |
| Memorials | All the memorials | For whom | People's opinions |
| | that are held at that | A picture or logo | Attendees |
| | particular | Day | Advertisements |
| | date/time at the | Start and end time | etc |
| | specified city | Venue | |
| | | Contact numbers and | |
| | | email addresses | |
| | | Website | |
| | | etc | |
| Discos | All the discos that | Type of music | Critics' reviews |
| | are open at that | A picture or logo | People's opinions |
| | particular | Start and end time | Advertisements |
| | date/time at the | Days | etc |
| | specified city | Venue | |
| | | Contact numbers and | |
| | | email addresses | |
| | | Reservation phone | |
| | | Website | |
| | | etc | |
| Circuses | All the circuses | Programs details | Critics' reviews |
| | that are performed | A picture or logo | People's opinions |
| | at that particular | Start and end time | Circuses background |
| | date/time at the | Days | Advertisements |
| | specified city | Duration | etc |
| | | Venue | |
| | | Contact numbers and | |
| | | email addresses | |
| | | Reservation phone | |
| | | Website | |
| | | etc | |
| Clubs | All the clubs that | Type of club | Critics' reviews |
| | are open at that | A picture or logo | People's opinions |
| | particular | Start and end time | Advertisements |
| | date/time at the | Days | etc |
| | specified city | Venue | |
| | | Contact numbers and | |
| | | email addresses | |
| | | Reservation phone | |
| | | Website | |
| | | etc | |
| Matches | All the matches | Type of match | Reviews |
| | that are held at that | Team names | People's opinions |
| | particular | A picture or logo | Advertisements |
| | date/time at the | Start and end time | etc |
| | specified city | Days | |
| | | Duration | |
| | | Venue | |
| | | Contact numbers and | |
| | | email addresses | |
| | | Reservation phone | |
| | | Website | |
| | | etc | |
| Holiday | All the holiday | Occasion, for ex., | People's opinions |
| events | events that are held | Christmas | Advertisements |
| | at that particular | Name of event | etc |
| | date/time at the | A picture or logo | |
| | specified city | Start and end time | |
| | | Days | |
| | | Duration | |
| | | Venue | |
| | | Contact numbers and | |
| | | email addresses | |
| | | Reservation phone | |
| | | Website | |
| | | etc | |
| Fairs and | All the fairs and | Types of fairs or | Reviews |
| festivals | festivals that are | festivals | People's opinions |
| | held at that | Programs details | Advertisements |
| | particular | A picture or logo | etc |
| | date/time at the | Start and end time | |
| | specified city | Days | |
| | | Duration | |
| | | Venue and contact | |
| | | numbers | |
| | | Reservation phone | |
| | | Email address | |
| | | Website | |
| | | etc | |
| Carnivals | All the carnivals | Type of carnival | Critics' reviews |
| | that are held at that | What for | People's opinions |
| | particular | A picture or logo | Advertisements |
| | date/time at the | Start and end time | etc |
| | specified city | Days | |
| | | Duration | |
| | | Venue | |
| | | Contact numbers and | |
| | | email addresses | |
| | | Reservation phone | |
| | | Website | |
| | | etc | |
| Community | All the community | Type of community | Reviews |
| services | services that are | service | People's opinions |
| | held at that | Helpers needed | Advertisements |
| | particular | For whom | etc |
| | date/time at the | A picture or logo | |
| | specified city | Start and end time | |
| | | Days | |
| | | Duration | |
| | | Venue | |
| | | Contact numbers and | |
| | | email addresses | |
| | | Reservation phone | |
| | | Website | |
| | | etc | |
| Games | All the games that | Name of game | Reviews |
| | are held at that | Type of game | People's opinions |
| | particular | Players' names | Advertisements |
| | date/time at the | A picture or logo | etc |
| | specified city | Start and end time | |
| | | Days | |
| | | Venue | |
| | | Contact numbers and | |
| | | email addresses | |
| | | Reservation phone | |
| | | Website | |
| | | etc | |
| Job Fairs | All the job fairs | For whom | Reviews |
| | that are held at that | Companies attending | People's opinions |
| | particular | A picture or logo | Advertisements |
| | date/time at the | Start and end time | etc |
| | specified city | Days | |
| | | Duration | |
| | | Venue | |
| | | Contact numbers and | |
| | | email addresses | |
| | | Website | |
| | | etc | |
| Reunions | All the reunions | Classes or companies | People's opinions |
| | that are held at that | of attendees | Advertisements |
| | particular | Name of attendees | etc |
| | date/time at the | A picture or logo | |
| | specified city | Day | |
| | | Start and end time | |
| | | Venue | |
| | | Contact numbers and | |
| | | email addresses | |
| | | Reservation phone | |
| | | etc | |
| Telethons | All the telethons | For whom | Critics' reviews |
| | that are held at that | A picture or logo | People's opinions |
| | particular | Start and end time | Donations |
| | date/time at the | Day | Advertisements |
| | specified city | Venue | etc |
| | | Contact numbers and | |
| | | email addresses | |
| | | Reservation phone | |
| | | Website | |
| | | etc | |
| Conferences | All the | Subject | Critics' reviews |
| | conferences that | For whom | People's opinions |
| | are held at that | Duration | Advertisements |
| | particular | A picture or logo | etc |
| | date/time at the | Days | |
| | specified city | Start and end time | |
| | | Venue and contact | |
| | | numbers | |
| | | Reservation phone | |
| | | Email address | |
| | | Website | |
| | | etc | |
| Sporting | All the sporting | Type of sporting event | Critics' reviews |
| events | events that are | A picture or logo | People's opinions |
| | done at that | Start and end time | Players' backgrounds |
| | particular | Days | Advertisements |
| | date/time at the | Duration | etc |
| | specified city | Venue and contact | |
| | | numbers | |
| | | Reservation phone | |
| | | Email address | |
| | | Website | |
| | | etc | |
| Exhibitions | All the exhibitions | Name of exhibition or | Critics' reviews |
| and Trade | and trade shows | trade show | People's opinions |
| Shows | that are held at that | What for | Advertisements |
| | particular | For whom | etc |
| | date/time at the | A picture or logo | |
| | specified city | Start and end time | |
| | | Days | |
| | | Duration | |
| | | Venue and contact | |
| | | numbers | |
| | | Reservation phone | |
| | | Email address | |
| | | Website | |
| | | etc | |
| Auctions | All the auctions | Name of auctions | Critics' reviews |
| | that are held at that | What for | People's opinions |
| | particular | For whom | Advertisements |
| | date/time at the | A picture or logo | etc |
| | specified city | Start and end time | |
| | | Days | |
| | | Duration | |
| | | Venue and contact | |
| | | numbers | |
| | | Reservation phone | |
| | | Email address | |
| | | Website | |
| | | etc | |
| Grand | All the grand | Store Name | Critics' reviews |
| Openings | openings that are | A picture or logo | People's opinions |
| | held at that | Days | Advertisements |
| | particular | Start and end time | etc |
| | date/time at the | List of Programs | |
| | specified city | Venue and contact | |
| | | numbers | |
| | | Email address | |
| | | Website | |
| | | Etc | |
| Parades | All the parades | Type of parade | Critics' reviews |
| | that are held at that | What for | People's opinions |
| | particular | A picture or logo | Advertisements |
| | date/time at the | Start and end time | etc |
| | specified city | Days | |
| | | Duration | |
| | | Venue | |
| | | Contact numbers and | |
| | | email addresses | |
| | | Website | |
| | | Etc | |

Table 3 will illustrate what the user will choose for services, what the search engine will list, what additional information is displayed for each service, and what additional information can the users write or upload. Please note that the search engine will search all websites in the World Wide Web and the Worldwide Billboard's database.

TABLE 3
Services

| The User | | | Additional Information |
|---|---|---|---|
| Will Choose | Search Engine | Along with These | that May Be Written or |
| (Services) | Will List | Useful Information | uploaded |
| Museums | All the museums | Museum's name | Critics' reviews |
| | that are open at | List of programs | People's opinions |
| | that particular | Type of artifacts | Summary of artifacts |
| | date/time at the | A picture or logo | Advertisements |
| | specified city | Days | etc |
| | | Start and end time | |
| | | Venue | |
| | | Contact numbers | |
| | | and email addresses | |
| | | Reservation phone | |
| | | Website | |
| | | etc | |
| Banks | All the banks that | Name of bank | People's opinions |
| | are open at that | A picture or logo | Loan's programs |
| | particular | Opening hours | Advertisements |
| | date/time at the | Venue | etc |
| | specified city | Contact numbers | |
| | | and email addresses | |
| | | Website | |
| | | etc | |
| Restaurants | All the restaurants | Name of restaurant | Critics' reviews |
| | that are open at | Type of restaurant | People's opinions |
| | that particular | A picture or logo | List of foods and prices |
| | date/time at the | Opening hours | Happy hours' discounts |
| | specified city | Venue | Advertisements |
| | PLUS all the | Contact numbers | etc |
| | restaurants that | and email addresses | |
| | have happy hours | Reservation phone | |
| | at that particular | Website | |
| | date/time at the | etc | |
| | specified city | | |
| Coffee shops | All the coffee | Name of coffee shop | Critics' reviews |
| | shops that are | Menu | People's opinions |
| | open at that | A picture or logo | Menu |
| | particular | Opening hours | Happy hours' discounts |
| | date/time at the | Happy hours' discounts | Advertisements |
| | specified city | Venue | etc |
| | PLUS all the | Contact numbers | |
| | coffee shops that | and email addresses | |
| | have happy hours | Reservation phone | |
| | at that particular | Website | |
| | date/time at the | etc | |
| | specified city | | |
| Bars and Pubs | All the bars and | Name of bar or pub | Critics' reviews |
| | pubs that are open | Type of bar or pub | People's opinions |
| | at that particular | Menu | Menu |
| | date/time at the | A picture or logo | Happy hours' discounts |
| | specified city | Opening hours | Programs if any |
| | PLUS all the bars | Happy hours' discounts | Advertisements |
| | and pubs that have | Venue | etc |
| | happy hours at | Contact numbers | |
| | that particular | and email addresses | |
| | date/time at the | Reservation phone | |
| | specified city | Website | |
| | PLUS all the bars | etc | |
| | and pubs that have | | |
| | special programs | | |
| Art centers | All the art centers | Type of art | Critics' reviews |
| | that are open at | List of programs | People's opinions |
| | that particular | Artists' names | Advertisements |
| | date/time at the | Art's style | etc |
| | specified city | A picture or logo | |
| | | Start and end time | |
| | | Opening hours | |
| | | Days | |
| | | Venue | |
| | | Contact numbers | |
| | | and email addresses | |
| | | Reservation phone | |
| | | Website | |
| | | Etc | |
| Galleries | All the galleries | Type of gallery | Critics' reviews |
| | that are open at | Artists' names | People's opinions |
| | that particular | Art's style | List of programs |
| | date/time at the | A picture or logo | Advertisements |
| | specified city | Start and end time | etc |
| | | Opening hours | |
| | | Days | |
| | | Venue | |
| | | Contact numbers | |
| | | and email addresses | |
| | | Reservation phone | |
| | | Website | |
| | | etc | |
| Tours | All the tours that | Type of tour, for ex., | Critics' reviews |
| | are offered at that | Boating Tours, | People's opinions |
| | particular | Garden Tours | Advertisements |
| | date/time at the | Tour's name, for ex., | Tour's program |
| | specified city | Venice | etc |
| | | A picture or logo | |
| | | Days | |
| | | Duration | |
| | | Start and end time | |
| | | Starting point | |
| | | Ending point | |
| | | Tour's program | |
| | | Contact numbers | |
| | | and email addresses | |
| | | Reservation phone | |
| | | Website | |
| | | etc | |
| Zoos | All the Zoos that | Type of zoo | Reviews |
| | are open at that | A picture or logo | People's opinions |
| | particular | Days | Advertisements |
| | date/time at the | Opening hours | etc |
| | specified city | Venue | |
| | | Contact numbers | |
| | | and email addresses | |
| | | Reservation phone | |
| | | Website | |
| | | etc | |
| TV programs | All the TV | Type of program | Critics' reviews |
| | programs that are | Name of program | People's opinions |
| | shown at that | A picture or logo | Advertisements |
| | particular | Days | etc |
| | date/time at the | Start and end time | |
| | specified city | Name of | |
| | | actors/actresses | |
| | | Website | |
| | | etc | |
| Baby sitter | All the baby sitter | Name of baby sitter | People's opinions |
| services | services that are | A picture or logo | Babysitters' background |
| | offered at that | Days | Advertisements |
| | particular | Start and end time | etc |
| | date/time at the | Contact numbers | |
| | specified city | and email addresses | |
| | | Reservation phone | |
| | | Website | |
| | | etc | |
| Nursing services | All the nursing | Name of nurse | People's opinions |
| | services that are | For whom | Nurses' background |
| | offered at that | A picture or logo | Advertisements |
| | particular | Days | etc |
| | date/time at the | Start and end time | |
| | specified city | Venue | |
| | | Contact numbers | |
| | | and email addresses | |
| | | Reservation phone | |
| | | Website | |
| | | etc | |
| Daycare Services | All the daycare | Name of daycare | People's opinions |
| | services that are | service | Background |
| | offered at that | For whom | Advertisements |
| | particular | A picture or logo | etc |
| | date/time at the | Days | |
| | specified city | Start and end time | |
| | | Venue | |
| | | Contact numbers | |
| | | and email addresses | |
| | | Reservation phone | |
| | | Website | |
| | | etc | |
| Stores | All the stores that | Name of store | Reviews |
| | are opened at that | Discount values | People's opinions |
| | particular | Products offered | Discount values |
| | date/time at the | A picture or logo | Advertisements |
| | specified city | Days | etc |
| | | Opening hours | |
| | | Venue | |
| | | Contact numbers | |
| | | and email addresses | |
| | | Website | |
| | | etc | |
| Shopping malls | All the shopping | Name of Shopping | Reviews |
| | malls that are | mall | People's opinions |
| | open at that | List of stores | Advertisements |
| | particular | Products offered | etc |
| | date/time at the | A picture or logo | |
| | specified city | Days | |
| | | Opening hours | |
| | | Venue | |
| | | Contact numbers | |
| | | and email addresses | |
| | | Website | |
| | | etc | |
| Stores sales and | All the stores | Name of store and | Reviews |
| discounts | sales and | shopping malls | People's opinions |
| | discounts that are | Discount values | Advertisements |
| | offered at that | Products offered | etc |
| | particular | A picture or logo | |
| | date/time at the | Days | |
| | specified city | Duration | |
| | | Start and end time | |
| | | Venue and contact | |
| | | numbers | |
| | | Email address | |
| | | Website | |
| | | etc | |
| Parks | All the parks that | Type of park for ex. | People's opinions |
| | are open at that | National, | Programs, if any |
| | particular | amusement, wild | Advertisements |
| | date/time at the | Programs, if any | etc |
| | specified city | A picture or logo | |
| | | Days | |
| | | Opening hours | |
| | | Venue | |
| | | Contact numbers | |
| | | and email addresses | |
| | | Website | |
| | | etc | |
| Aquariums | All the aquariums | Aquarium Name | Reviews |
| | that are open at | Types of fishes | People's opinions |
| | that particular | A picture or logo | Advertisements |
| | date/time at the | Days | etc |
| | specified city | Opening hours | |
| | | Venue | |
| | | Contact numbers | |
| | | and email addresses | |
| | | Reservation phone | |
| | | Website | |
| | | etc | |
| Libraries | All the libraries | Library name | Reviews |
| | that are open at | Types of books | People's opinions |
| | that particular | A picture or logo | Books excerpts |
| | date/time at the | Days | Advertisements |
| | specified city | Opening hours | etc |
| | | Venue | |
| | | Contact numbers | |
| | | and email addresses | |
| | | Website | |
| | | etc | |
| Doctors | All the doctors | Name of doctor | People's opinions |
| | that are visiting at | Specialty | Doctors' background |
| | that particular | A picture or logo | Advertisements |
| | date/time at the | Days | etc |
| | specified city | Visiting Hours | |
| | | Venue | |
| | | Contact numbers | |
| | | and email addresses | |
| | | Reservation phone | |
| | | Website | |
| | | etc | |
| Bus Schedules | All the bus | Name of bus | Critics' reviews |
| | schedules that are | Origin | People's opinions |
| | offered at that | Destination | Advertisements |
| | particular | A picture or logo | etc |
| | date/time at the | Days | |
| | specified city | Start and end time | |
| | | Types of services | |
| | | available | |
| | | Classes offered | |
| | | Station Venue | |
| | | Contact numbers | |
| | | and email addresses | |
| | | Reservation phone | |
| | | Website | |
| | | etc | |
| Train Schedules | All the train | Name of Train | Critics' reviews |
| | schedules that are | Origin | People's opinions |
| | offered at that | Destination | Advertisements |
| | particular | A picture or logo | etc |
| | date/time at the | Days | |
| | specified city | Start and end time | |
| | | Types of services | |
| | | available | |
| | | Classes offered | |
| | | Station Venue | |
| | | Contact numbers | |
| | | and email addresses | |
| | | Reservation phone | |
| | | Website | |
| | | etc | |
| Airplane | All the airplane | Name of Airplane | Critics' reviews |
| Schedules | schedules that are | Origin | People's opinions |
| | offered at that | Destination | Advertisements |
| | particular | A picture or logo | etc |
| | date/time at the | Days | |
| | specified city | Start and end time | |
| | | Types of services | |
| | | available | |
| | | Classes offered | |
| | | Station Venue | |
| | | Contact numbers | |
| | | and email addresses | |
| | | Reservation phone | |
| | | Website | |
| | | etc | |
| Bus Excursions | All the bus | Name of bus | Critics' reviews |
| | excursions that | Destination | People's opinions |
| | are offered at that | Origin | Advertisements |
| | particular | A picture or logo | etc |
| | date/time at the | Start and end time | |
| | specified city | Days | |
| | | Duration | |
| | | Types of services | |
| | | available | |
| | | For whom | |
| | | Type of excursion | |
| | | Classes offered | |
| | | Venue | |
| | | Contact numbers | |
| | | and email addresses | |
| | | Reservation phone | |
| | | Website | |
| | | etc | |
| Train Excursions | All the train | Name of Train | Critics' reviews |
| | excursions that | Destination | People's opinions |
| | are offered at that | Origin | Advertisements |
| | particular | A picture or logo | etc |
| | date/time at the | Start and end time | |
| | specified city | Duration | |
| | | Days | |
| | | Types of services | |
| | | available | |
| | | For whom | |
| | | Type of excursion | |
| | | Classes offered | |
| | | Venue | |
| | | Contact numbers | |
| | | and email addresses | |
| | | Reservation phone | |
| | | Website | |
| | | etc | |
| Airplane | All the airplane | Name of Airplane | Critics' reviews |
| Excursions | excursions that | Destination | People's opinions |
| | are offered at that | Origin | Advertisements |
| | particular | A picture or logo | etc |
| | date/time at the | Start and end time | |
| | specified city | Duration | |
| | | Days | |
| | | Types of services | |
| | | available | |
| | | For whom | |
| | | Type of excursion | |
| | | Classes offered | |
| | | Venue | |
| | | Contact numbers | |
| | | and email addresses | |
| | | Reservation phone | |
| | | Website | |
| | | etc | |
| Bus discounts | All the bus | Name of bus | Critics' reviews |
| | discounts that | Destination | People's opinions |
| | are offered at that | Origin | Advertisements |
| | particular | A picture or logo | etc |
| | date/time at the | Start and end time | |
| | specified city | Duration | |
| | | Days | |
| | | Types of services | |
| | | available | |
| | | For whom | |
| | | Type of discounts | |
| | | Classes offered | |
| | | Venue | |
| | | Contact numbers | |
| | | and email addresses | |
| | | Reservation phone | |
| | | Website | |
| | | etc | |
| Train discounts | All the train | Name of Train | Critics' reviews |
| | discounts that | Destination | People's opinions |
| | are offered at that | Origin | Advertisements |
| | particular | A picture or logo | etc |
| | date/time at the | Start and end time | |
| | specified city | Duration | |
| | | Days | |
| | | Types of services | |
| | | available | |
| | | For whom | |
| | | Type of discounts | |
| | | Classes offered | |
| | | Venue | |
| | | Contact numbers | |
| | | and email addresses | |
| | | Reservation phone | |
| | | Website | |
| | | etc | |
| Airplane | All the airplane | Name of Airplane | Critics' reviews |
| discounts | discounts that | Destination | People's opinions |
| | are offered at that | Origin | Advertisements |
| | particular | A picture or logo | etc |
| | date/time at the | Start and end time | |
| | specified city | Duration | |
| | | Days | |
| | | Types of services | |
| | | available | |
| | | For whom | |
| | | Type of discounts | |
| | | Classes offered | |
| | | Venue | |
| | | Contact numbers | |
| | | and email addresses | |
| | | Reservation phone | |
| | | Website | |
| | | Etc | |
| Hotels and | All the hotel and | Name | Reviews |
| Accommodations | accommodations | Class Type | People's opinions |
| | at the specified | A picture or logo | Advertisements |
| | city | Venue | etc |
| | | Contact numbers | |
| | | and email addresses | |
| | | Reservation phone | |
| | | Website | |
| | | etc | |
| Shuttles | All the shuttle | Name of shuttle | People's opinions |
| | services that are | service | Advertisements |
| | offered at that | Destination | etc |
| | particular | Origin | |
| | date/time at the | A picture or logo | |
| | specified city | Start and end time | |
| | | Days | |
| | | For whom | |
| | | Venue | |
| | | Contact numbers | |
| | | and email addresses | |
| | | Website | |
| | | Etc | |

Table 4 will illustrate upon entering the private code, what the user will see for each private event.

TABLE 4
Private Events

| Events and | Search Engine | Along with These |
|---|---|---|
| Happenings | Will List | Useful Information |
| Trainings | The training with the | Name of training |
| | specified private code | Detail about training |
| | will be displayed. | Name of instructor |
| | | A picture or logo |
| | | Start and end time |
| | | Days |
| | | Duration |
| | | For whom |
| | | Venue |
| | | Contact numbers and email |
| | | addresses |
| | | Reservation phone |
| | | Website |
| | | etc |
| Gatherings | The gathering with | Type of gallery |
| | the specified private | List of programs |
| | code will be | Artists' names |
| | displayed. | Art's style |
| | | A picture or logo |
| | | Start and end time |
| | | Opening hours |
| | | Days |
| | | Venue |
| | | Contact numbers and email |
| | | addresses |
| | | Reservation phone |
| | | Website |
| | | etc |
| Memorials | The memorial with | For whom |
| | the specified private | Attendees |
| | code will be | A picture or logo |
| | displayed. | Day |
| | | Start and end time |
| | | Venue |
| | | Contact numbers and email |
| | | addresses |
| | | Website |
| | | etc |
| Tours | The tour with the | Type of tour, for ex., |
| | | Boating Tours, Garden |
| | specified private code | Tours |
| | will be displayed. | Tour's name, for ex., |
| | | Venice |
| | | A picture or logo |
| | | Days |
| | | Duration |
| | | Start and end time |
| | | Starting point |
| | | Ending point |
| | | Tour's program |
| | | Contact numbers and email |
| | | addresses |
| | | Reservation phone |
| | | Website |
| | | etc |
| Matches | The match with the | Type of match |
| | specified private code | Team names |
| | will be displayed. | A picture or logo |
| | | Start and end time |
| | | Days |
| | | Duration |
| | | Venue |
| | | Contact numbers and email |
| | | addresses |
| | | Reservation phone |
| | | Website |
| | | etc |
| Holiday events | The holiday event | Occasion, for ex., Christmas |
| | with the specified | Name of event |
| | private code will be | A picture or logo |
| | displayed. | Start and end time |
| | | Days |
| | | Duration |
| | | Venue |
| | | Contact numbers and email |
| | | addresses |
| | | Reservation phone |
| | | Website |
| | | etc |
| Reunions | The reunion with the | Classes or companies of |
| | | attendees |
| | specified private code | Name of attendees |
| | will be displayed. | A picture or logo |
| | | Day |
| | | Start and end time |
| | | Venue |
| | | Contact numbers and email |
| | | addresses |
| | | Reservation phone |
| | | etc |
| Birthdays | The birthday with the | Whose birthday |
| | specified private code | Attendees |
| | will be displayed. | A picture or logo |
| | | Day |
| | | Start and end time |
| | | Venue |
| | | Contact numbers and email |
| | | addresses |
| | | etc |
| Anniversaries | The anniversary with | Occasion |
| | the specified private | Attendees |
| | code will be | A picture or logo |
| | displayed. | Day |
| | | Start and end time |
| | | Venue |
| | | Contact numbers and email |
| | | addresses |
| | | etc |
| Parties | The party with the | For whom |
| | specified private code | For what |
| | will be displayed. | Dress code |
| | | A picture or logo |
| | | Day |
| | | Start and end time |
| | | Venue and contact numbers |
| | | Email address |
| | | etc |
| Weddings | The wedding with the | Name of bride |
| | specified private code | Name of groom |
| | will be displayed. | Guest list |
| | | A picture or logo |
| | | Day |
| | | Start and end time |
| | | Venue and contact numbers |
| | | Email address |
| | | Website |
| | | etc |
| Conferences | The conference with | Subject |
| | the specified private | For whom |
| | code will be | A picture or logo |
| | displayed. | Duration |
| | | Days |
| | | Start and end time |
| | | Venue and contact numbers |
| | | Reservation phone |
| | | Email address |
| | | Website |
| | | etc |
| Sporting events | The sporting event | Type of sporting event |
| | with the specified | Start and end time |
| | private code will be | A picture or logo |
| | displayed. | Days |
| | | Duration |
| | | Venue and contact numbers |
| | | Reservation phone |
| | | Email address |
| | | Website |
| | | etc |
| Auctions | The auction with the | Name of auctions |
| | specified private code | What for |
| | will be displayed. | For whom |
| | | A picture or logo |
| | | Start and end time |
| | | Days |
| | | Duration |
| | | Venue and contact numbers |
| | | Reservation phone |
| | | Email address |
| | | Website |
| | | etc |

Information listed in Tables 2, 3, 4 are just illustrations; other private events, public events, and services may be located or posted. As it is obvious, based on the chosen event or service, the useful information will change accordingly. To provide a thorough description of the present invention, many details have been explained in the above document. In some instances, well known features such as indexing, web crawling, and making reservations have not been explained in detail so as not to obscure the present invention.
Particular embodiments described herein are illustrative only but not restrictive; they should not limit the present invention thereby; many variations of the invention will become apparent to those skilled in the art upon review of the disclosure. The scope of the invention should, therefore, be determined not with reference to the above description.

The embodiment of the invention in which an exclusive property or privilege is claimed are defined as follows:

1. A website that focuses on all events and services worldwide, the website comprising:
a) an event search engine generating and outputting a search result regarding worldwide events based on the events' time and location of occurrence;
b) a service search engine generating and outputting a search result regarding worldwide services based on the services' time and location of occurrence; and
c) a means for posting and announcing services and events.

2. The website of claim 1, further comprising a database.

3. The website of claim 1, wherein the search result comprises information found in the world wide web (www), and in the database.

4. The website of claim 1, wherein the search result may be sent to an event and service basket.

5. The website of claim 1, wherein the website is used for making a reservation among the search result.

6. The website of claim 1, wherein the website is used for writing a comment regarding the services and events.

7. The website of claim 1, wherein the website is used for writing a detail information regarding the services and events.

8. The website of claim 1, wherein the website is used for uploading a file regarding the services and events.

9. The website of claim 1, wherein the website is used for grading the search result.
